(19) United States
(12) Patent Application Publication
(10) Pub. No.: US 2015/0208412 A1
(43) Pub. Date: Jul. 23, 2015

(54) COMMUNICATION SYSTEM, COMMUNICATION DEVICE, AND COMMUNICATION METHOD

(71) Applicants: SHARP KABUSHIKI KAISHA, Osaka-shi, Osaka (JP); OSAKA UNIVERSITY, Suita-shi, Osaka (JP)

(72) Inventors: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP); Seiichi Sampei, Suita-shi (JP); Shinsuke Ibi, Suita-shi (JP); Shinichi Miyamoto, Suita-shi (JP)

(73) Assignees: OSAKA UNIVERSITY, Suita-shi, Osaka (JP); SHARP KABUSHIKI KAISHA, Osaka-shi, Osaka (JP)

(21) Appl. No.: 14/421,114

(22) PCT Filed: Aug. 13, 2013
(86) PCT No.: PCT/JP2013/071894

§ 371 Date: Feb. 11, 2015

(30) Foreign Application Priority Data
Aug. 14, 2012 (JP) 2012-179871

(51) Int. Cl. H04W 72/04

(52) U.S. Cl. CPC H04W 72/0453

(57) ABSTRACT

A wireless communication system includes a first communication device and a second communication device, in which the first communication device includes a cyclostationarity assignment unit that establishes a correlation between signals on two subcarriers that are a predetermined interval away from each other, the two subcarriers including at least one subcarrier on which a data signal to be transmitted to the second communication device is arranged, and the second communication device includes a frequency interval determination unit that determines the predetermined frequency interval according to information that has to be notified to a different device by the first communication device. Thus, a communication system is provided that is capable of suppressing a decrease in frame efficiency when assigning cyclostationarity.

### TECHNICAL FIELD

The present invention relates to a communication system, a communication device, and a communication method. This patent application claims the benefit of priority of Japanese Patent Application No. 2012-179871 filed in Japan on Aug. 14, 2012, the contents of which are herein incorporated by reference.

### BACKGROUND ART

In many wireless access systems, a wireless band with a given bandwidth takes on a form of management by each system, but in such a form, transmission performance fluctuates widely due to a channel change that accompanies a movement of a terminal. In a case of a self-management wireless access system to which Carrier Sense Multiple Access with Collision Avoidance (CSMA/CA) is applied, there is a problem in that packet collision due to a hidden terminal problem occurs and the transmission performance is decreased.

To deal with the problem, a dynamic spectrum control (DSC) technology is proposed in which, provided that a given band is frequency-shared among multiple users, each user properly selects and transmits a spectrum that has a high channel capacity according to frequency characteristics within a wireless band. In such a method, by autonomously acquiring a discrete spectrum that has a high channel gain, each user realizes improvement in signal to interference plus noise power ratio (SINR) within a channel due to a user diversity effect and improves transmission performance.

Additionally, in NPL 1, a method is proposed in which each user autonomously determines a band to be used while monitoring an interference situation within a band.

At this point, when each user autonomously determines the band to be used, fairness in allocating a transmission opportunity to each user is not secured. One solution for securing the fairness is to install a central control station and grasp and control the number of users that make a connection.

However, in an independent distribution system, cooperation itself among multiple central control stations is not realistic. Therefore, in the autonomous distribution system, a technology in which the fairness in allocating the transmission opportunity to each user is ensured is recommended.

When the bandwidth is determined considering the fairness, the grasping of the number of users that make a connection at the same time is of significance, but in such a case, when grasping the number of users, it is recommended to grasp the number of users without sharing knowledge relating to a spectrum or a band that is used by each user.

In PTL 1, it is disclosed that, as a technology that assigns an ID to a signal regardless of a modulation scheme for a signal waveform and the like, there is a cyclostationarity assignment technology, and, in order to assign the cyclostationarity for a cyclic frequency f1, the same signal may be copied to a frequency component that is only f1 away in terms of frequency.

### CITATION LIST

### Patent Literature

PTL 1: Japanese Unexamined Patent Application Publication No. 2008-61214

### Non Patent Literature

NPL 1: T. Aoki, S. Ibi and S. Sampei, “Enhancement of throughput Efficiency using Adaptive Bandwidth Control for Autonomous Distributed networks in Multiuser Environments,”

### SUMMARY OF INVENTION

### Technical Problem

However, in the cyclostationarity assignment technology in PTL 1, a subcarrier is occupied for cyclostationarity assignment. For this reason, when the number of the subcarriers for the cyclostationarity assignment is increased in order to improve detection accuracy of the cyclostationarity, a problem of causing a decrease in a frame efficiency occurs.

An object of the present invention, which is made in view of this situation, is to provide a communication system, a communication device, and a communication method for suppressing a decrease in a frame efficiency that occurs when assigning cyclostationarity.

### Solution to Problem

(1) According to an aspect of the present invention, there is provided a communication system including: a first communication device; and a second communication device, in which the first communication device or the second communication device include a frequency interval determination unit that determines a predetermined frequency interval according to information that has to be notified to a different device by the first communication device, and in which the first communication device includes a cyclostationarity assignment unit that establishes a correlation between signals on two subcarriers that are the predetermined frequency interval away from each other, the two subcarriers including at least one subcarrier on which a data signal to be transmitted to the second communication device is arranged.

(2) Furthermore, according to the embodiment of the present invention, in the communication system according to (1), the cyclostationarity assignment unit may establish the correlation between the signals on the two subcarriers by arranging a copy of the signal on one subcarrier of the two subcarriers, on which the data signal is arranged, on the other subcarrier.

(3) Furthermore, according to the embodiment of the present invention, in the communication system according to (2), the other subcarrier may be a subcarrier on which the data signal is not arranged, and the first communication device or the second communication device may include a cyclostationarity determination unit that selects a subcarrier on which the data signal is not arranged and which has the highest gain, from among the subcarriers, the data signal being arranged on a subcarrier that is the predetermined frequency interval away from the subcarriers, and sets the selected subcarrier to be the other subcarrier.

(4) Furthermore, according to the embodiment of the present invention, in the communication system according to (2),

the first communication device or the second communication device may include a cyclostationarity determination unit that selects a subcarrier that has the lowest gain from among subcarriers on each of which the data signal is arranged, and sets the selected subcarrier to be the one subcarrier.

(5) Furthermore, according to the embodiment of the present invention, in the communication system according to (1), the two subcarriers may be subcarriers on each of which the data signal is arranged, and the cyclostationarity assignment unit may arrange a signal that is based on an exclusive-OR between bits that are indicated by each signal on the two subcarriers, and thus may establish the correlation between the signals on the two subcarriers.

(6) Furthermore, according to the embodiment of the present invention, in the communication system according to (5), the second communication device may include a combination unit that combines pieces of information relating to the signal that is based on the exclusive-OR, in a signal received from the first communication device, a decoding unit that decodes the received signal, and a XOR bit calculation unit that calculates information indicating a value of the bit that results from the exclusive-OR, from a result of the combination by the combination unit and a result of the decoding by the decoding unit.

(7) According to another aspect of the present invention, there is provided a communication device that communicates with a first communication device that establishes a correlation between signals on two subcarriers that are a predetermined frequency interval away from each other, the two subcarriers including at least one subcarrier on which a data signal to be transmitted is arranged, the device includes a frequency interval determination unit that determines the predetermined frequency interval according to information that has to be notified to a different device by the first communication device.

(8) According to a further aspect of the present invention, there is provided a communication device including: a cyclostationarity assignment unit that establishes a correlation between signals on two subcarriers that are a predetermined frequency interval away from each other, the two subcarriers including at least one subcarrier on which a data signal to be transmitted to a different communication device is arranged.

(9) Furthermore, according to a still further aspect of the present invention, there is provided a communication method including: a first step of determining a predetermined frequency interval according to information that has to be notified; and a second step of establishing a correlation between signals on two subcarriers that are the predetermined frequency interval away from each other, the two subcarriers including at least one subcarrier on which a data signal to be transmitted is arranged.

### Advantageous Effects of Invention

According to the invention, a decrease in a frame efficiency that occurs when assigning cyclostationarity can be suppressed.

### BRIEF DESCRIPTION OF DRAWINGS

FIG. 1 is a schematic block diagram illustrating a configuration of a wireless communication system 10 according to a first embodiment of the present invention.

FIG. 2 is a schematic block diagram of a configuration of a terminal device 200 according to the same embodiment.

FIG. 3 is a diagram for describing operation of a cyclostationarity assignment unit 205 according to the same embodiment.

FIG. 4 is a schematic block diagram illustrating a configuration of an ID acquirement unit 217 according to the same embodiment.

FIG. 5 is a schematic block diagram illustrating a configuration of a base station device 100 according to the same embodiment.

FIG. 6 is a schematic block diagram illustrating a configuration example of a data processing unit 106 according to the same embodiment.

FIG. 7 is a flowchart for describing operation of a scheduling unit 108 and operation of a cyclostationarity determination unit 113 according to the same embodiment.

FIG. 8 is a diagram for describing operation of the cyclostationarity determination unit 113 according to the same embodiment.

FIG. 9 is another diagram for describing the operation of the cyclostationarity determination unit 113 according to the same embodiment.

FIG. 10 is a flowchart for describing operation of the scheduling unit 108 and operation of the cyclostationarity determination unit 113 in a modification example according to the same embodiment.

FIG. 11 is a schematic block diagram illustrating a configuration of a cyclostationarity assignment unit 205a according to a second embodiment of the present invention.

FIG. 12 is a conceptional diagram for describing processing by the cyclostationarity assignment unit 205a according the same embodiment.

FIG. 13 is a schematic block diagram illustrating a configuration of a data processing unit 106a according to the same embodiment.

### DESCRIPTION OF EMBODIMENTS

### First Embodiment

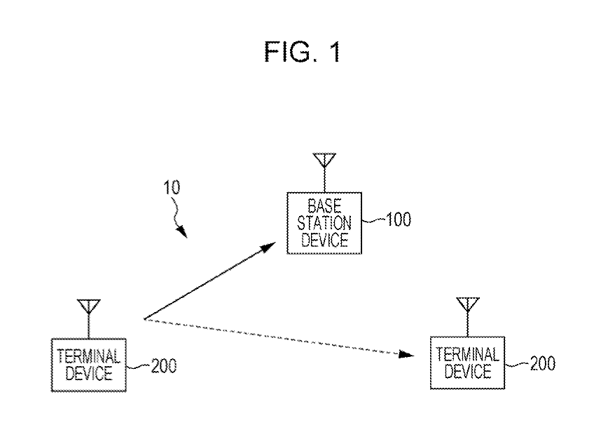

A first embodiment according to the present invention is described below referring to the drawings. FIG. 1 is a schematic block diagram illustrating a configuration of a wireless communication system 10 according to a first embodiment of the present invention. The wireless communication system 10 is configured to include a base station device 100 (second communication device), and multiple terminal devices 200 (first communication device). Moreover, two of the terminal devices 200 are illustrated in FIG. 1, but this is an example. The multiple terminal devices 200 have the same configuration in terms of a broad outline, but different ID's are allocated to the multiple terminal devices 200.

Furthermore, according to the present embodiment, a case where Orthogonal Frequency Division Multiplexing (OFDM) is used as a transmission scheme is described. However, single carrier transmission may be used, and a transmission scheme that spreads the OFDM may be used as is the case with Multi-Carrier Code Division Multiple Access (MC-CDMA). Furthermore, a case where the number of transmit antennas is 1 in transmission from the terminal device 200 is described. However, the number of transmit antennas may be 2 or greater and a known transmission method may be used such as transmit antenna diversity or MIMO multi-transmission.

The terminal device 200 modulates data into a signal that occupies a predetermined bandwidth. In so doing, a modulation signal to which cyclostationarity in accordance with an ID of the terminal device 200 is assigned is transmitted to the base station device 100. While it is received in the base station device 100, the transmitted signal is received in a different terminal device 200. Without performing demodulation for the data, the different terminal devices 200 can recognize that the terminal device 200 performs communication, by detecting the cyclostationarity that is assigned.

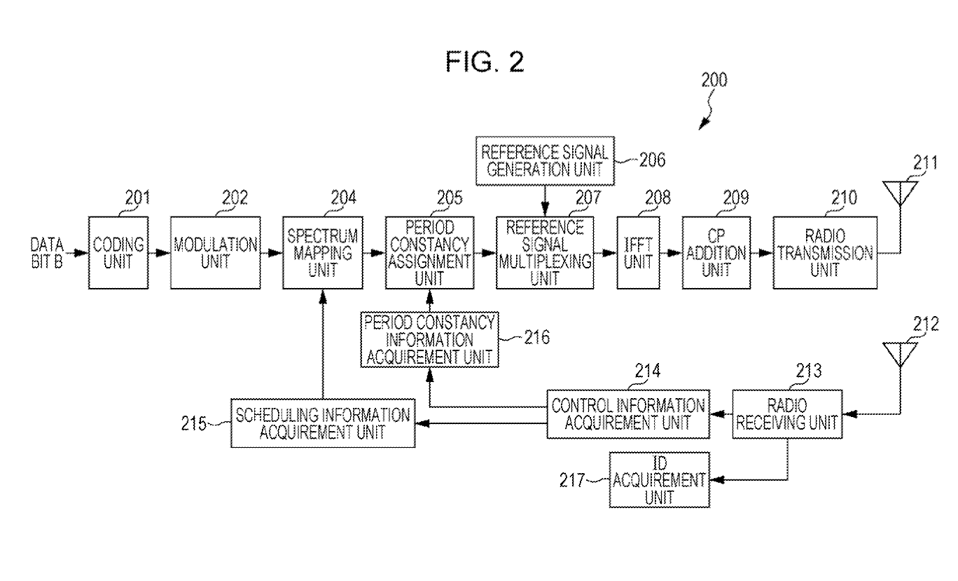

FIG. 2 is a schematic block diagram illustrating a configuration of the terminal device 200. The terminal device 200 is configured to include a coding unit 201, a demodulation unit 202, a spectrum mapping unit 204, a cyclostationarity assignment unit 205, a reference signal generation unit 206, a reference signal multiplexing unit 207, an IFFT unit 208, a CP addition unit 209, a wireless transmission unit 210, a transmit antenna 211, a receive antenna 212, a wireless reception unit 213, a control information acquirement unit 214, a scheduling information acquirement unit 215, a cyclostationarity information acquirement unit 216, and an ID acquirement unit 217.

The coding unit 201 performs error correction coding on a data bit B that is transmitted to the base station device 100 and generates the coded bits. In the error correction coding, for example, a turbo code, a low density parity check (LDPC) code, and the like are used. Moreover, the data bit B may be a bit indicating so-called user data, and may be a bit indicating control information. The demodulation unit 202 performs modulation, such as Quadrature Phase Shift Keying (QPSK) or 16-ary Quadrature Amplitude Modulation (16 QAM), on the coded bit that is generated by the coding unit 201, and generates a modulation symbol (data signal). The demodulation unit 202 inputs a modulation signal S that is made from Nₛ modulation symbols into the spectrum mapping unit 204.

The spectrum mapping unit 204 arranges each modulation symbol of the modulation signal S in a frequency (subcarrier) that is designated in scheduling information Sc that is acquired by the scheduling information acquirement unit 215, and generates a frequency signal fs. Moreover, the scheduling information Sc is information that designates Nₛ subcarriers, among N_{FFT} subcarriers that make up a system band, as a subcarrier that is used for transmission by the terminal device 200. However, N_{FFT}≧Nₛ. According to the present embodiment because the modulation symbol is carried in the OFDM by the subcarrier, the modulation symbol is referred to as a spectrum.

The cyclostationarity assignment unit 205 assigns the cyclostationarity to a frequency signal that is generated by the spectrum mapping unit 204, according to cyclostationarity information being input from the cyclostationarity information acquirement unit 216, and generates a transmission signal Fs. Specifically, the cyclostationarity assignment unit 205 copies a signal on a first subcarrier, among frequency signals that are generated by the spectrum mapping unit 204, and arranges a copy of the signal on a second subcarrier, without the spectrum mapping unit 204 arranging a modulation symbol. That is, the cyclostationarity assignment unit 205 establishes a correlation between signals on two subcarriers that include at least one subcarrier on which a data signal is arranged and that are a predetermined frequency interval away from each other. Moreover, the cyclostationarity information is information that designates the first subcarrier described above and the second subcarrier, and a predetermined frequency interval is designated by designating these pieces of information.

The reference signal generation unit 206 generates a reference signal. Moreover, the reference signal that is generated by the reference signal generation unit 206 is a signal known between the terminal device 200 and the base station device 100, and is used in the base station device 100 for compensating for an influence on a channel or determining which subcarrier is used to perform transmission when a next transmission opportunity is provided. In order to make up a transmission frame, the reference signal multiplexing unit 207 multiplexes the reference signal generated by the reference signal generation unit 206 and the transmission signal Fs to which the cyclostationarity assignment unit 205 assigns the cyclostationarity. Moreover, according to the present embodiment, the reference signal and the transmission signal Fs are time-multiplexed, but may be multiplexed using other multiplexing methods.

The IFFT unit 208 performs conversion of a frequency domain signal to a time domain signal by applying Inverse Fast Fourier Transform at an N_{FFT} point to the signal multiplexed by the reference signal multiplexing unit 207. The CP addition unit 209 performs addition of a cyclic prefix (CP) at every N_{FFT} point on the time domain signal that results from the conversion by the IFFT unit 208. The wireless transmission unit 210 applies digital/analogue (D/A) conversion, filtering processing, up-conversion to a carrier frequency, and the like to the signal to which the CP is added, and transmits the result from the transmit antenna 211.

The receive antenna 212 receives the signal that is transmitted by the base station device 100 and the different terminal device 200. The wireless reception unit 213 performs down-conversion to a baseband, filtering processing, analogue/digital (A/D) conversion, and the like on the signal that is received by the receive antenna 212, and converts the result into a digital received signal. The control information acquirement unit 214 detects the control information that is transmitted by the base station device 100 from the digital received signal. The scheduling information acquirement unit 215 extracts the scheduling information Sc from the detected control information.

The cyclostationarity information acquirement unit 216 extracts the cyclostationarity information from the control information detected by the control information acquirement unit 214. At this point, the cyclostationarity information is information indicating the subcarrier (first subcarrier) that is a copy source when copying the signal in the cyclostationarity assignment unit 205, and the cyclostationarity assignment subcarrier (second subcarrier) that is a copy destination. The ID acquirement unit 217 detects the cyclostationarity in the digital received signal that is generated by the wireless reception unit 213, and based on a period in the cyclostationarity, acquires an ID of the different terminal device 200 that transmits the signal. Moreover, the ID acquirement unit 217 will be described in detail below.

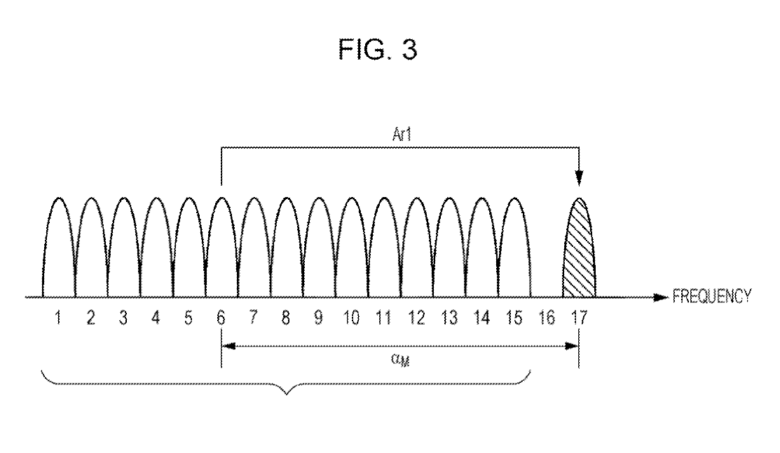

FIG. 3 is a diagram for describing operation of the cyclostationarity assignment unit 205. In FIG. 3, a horizontal axis indicates a frequency, and numerical values along the horizontal axis are subcarrier numbers. That is, the subcarrier numbers are consecutive numbers in increasing order of frequency, which are assigned to the subcarriers.

In an example in FIG. 3, 15 subcarriers of which subcarrier numbers are 1 to 15 are designated by the scheduling information Sc, and the modulation signal S is arranged on these subcarriers. Furthermore, with the cyclostationarity information, the subcarrier number 6 is designated as the first subcarrier that is the copy source, and the subcarrier number 17 is designated as the second subcarrier that is the copy destination. Moreover, thereafter, the subcarrier on which the spectrum mapping unit 204 arranges the modulation signal S is referred to as a data subcarrier.

At this time, the cyclostationarity assignment unit 205, as indicated by an arrow Ar1, copies a signal on the subcarrier number 6, and arranges a copy of the signal on the subcarrier number 17 as a cyclostationarity subcarrier. Accordingly, the cyclostationarity representing an interval between the subcarrier number 6 and the subcarrier number 17, that is, a frequency interval αₘ=11, is assigned to the transmission signal. Moreover, the frequency interval αₘ, as described below, is a value in an ID of the terminal device 200.

Moreover, in FIG. 3, the cyclostationarity subcarrier on which the copy of the signal is arranged is isolated from the data subcarrier, but may be adjacent to the data subcarrier. Furthermore, in FIG. 3, the cyclostationarity subcarrier is a subcarrier that is not designated in the scheduling information Sc, that is, a subcarrier that is not the data subcarrier, but is not limited to such a subcarrier. That is, the data subcarrier may be set to be the cyclostationarity subcarrier. For example, even though a subcarrier of which the subcarrier number is 17 is a data subcarrier, a copy of a spectrum of the sixth subcarrier may be arranged instead of an original data spectrum.

Additionally, the cyclostationarity assignment unit 205 may perform shift rotation on the copy of the signal and then may arrange the resulting copy of the signal on the subcarrier. For example, a combination of a frequency interval and an amount of the phase rotation is associated with the ID of the terminal device 200, and thus more ID's are identifiable. Furthermore, a detection rate of the cyclostationarity in the different terminal device 200 can be improved by performing the phase rotation. Because in a case of, for example, the QPSK, four types of the modulation symbol are present, the same signal point constellation as for a certain subcarrier is transmitted with a 25% probability in a subcarrier that is at the frequency interval αₘ from the certain subcarrier. In contrast, deterioration in the detection rate due to an accidental signal-point coincidence can be suppressed, for example, by performing π/4 phase rotation.

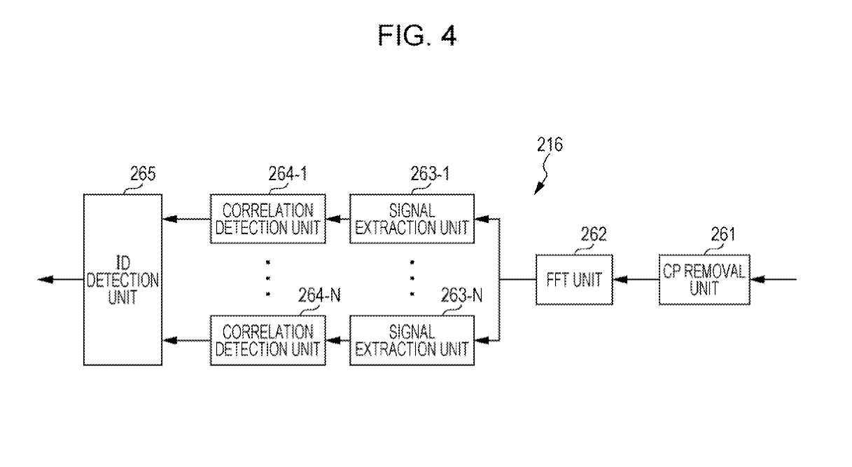

FIG. 4 is a schematic block diagram illustrating a configuration of the ID acquirement unit 217. The ID acquirement unit 217 is configured to include a CP removal unit 261, an FFT unit 262, N signal extraction unit 263-1 to 263-N, N correlation detection units 264-1 to 264-N, and an ID detection unit 265. At this point, N is the number of ID's that are identifiable. The CP removal unit 261 removes the cyclic prefix from the digital received signal generated by the wireless reception unit 213. The FFT unit 262 performs Fast Fourier Transform on the signal from which the cyclic prefix is removed, and converts the resulting signal into a signal in the frequency domain.

The signal extraction units 263-1 to 263-N each extract a set of subcarriers for detecting the cyclostationarity corresponding to a specific ID from the signal in the frequency domain, which is generated by the FFT unit 262. For example, when the cyclostationarity that is detected by the signal extraction unit 263-1 represents 10, the signal extraction unit 263-1 extracts all sets, between numbers of the subcarriers in each of which there is a difference of 10. That is, the signal extraction unit 263-1 extracts a set of the subcarrier numbers 263-1 and 263-11, a set of the subcarrier numbers 263-2 and 263-12, a set of the subcarrier numbers 263-3 and 263-13, and so forth up to a set of the subcarrier numbers N_{FFT}-10 and N_{FFT}. Each of the correlation detection units 264-1 to 264-N calculates correlations in all the sets that are extracted by each of the signal extraction units 263-1 to 263-N that correspond to the correlation detection units, respectively, adds up the correlations and outputs the result. At this point, in the extracted set, a signal on the subcarrier that has the first subcarrier number is set to be R1(t), and a signal on the subcarrier that has the second subcarrier number is set to be R2(t). At this time, the correlation in the set is calculated by R1(t)×R2(t)*. Moreover, * is an operator indicating a complex conjugate.

The ID detection unit 265 determines whether or not an output from each of the correlation detection units 264-1 to 264-N is greater than a threshold that is set in advance, and when it is determined that the output is greater than the threshold, sets an ID corresponding to the output to be a detected ID. In so doing, when multiple ID's that are greater than the threshold are present, the multiple ID's are detected. For example, when it is determined that outputs of the correlation detection unit 264-1 and the correlation detection unit 264-3 are greater than the threshold, an ID corresponding to the signal extraction unit 263-1 and an ID corresponding to the signal extraction unit 263-3 are set to be detected ID's. On the other hand, when it is determined that all outputs are not greater than the threshold, the ID detection unit 265 sets an ID not to be detected.

Moreover, when calculating the correlation, the correlation detection units 264-1 and 264-N may calculate, for example, a sum or average over a predetermined amount of time, such as one frame.

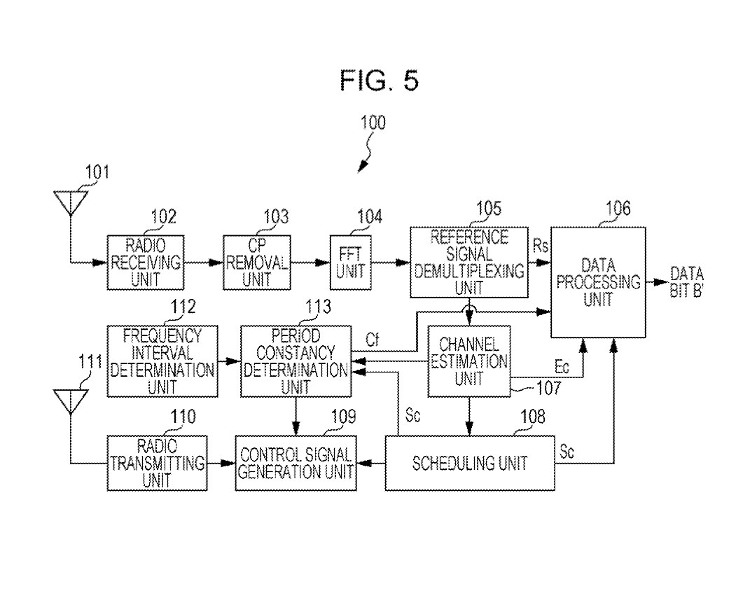

FIG. 5 is a schematic block diagram illustrating a configuration of the base station device 100. The base station device 100 is configured to include a receive antenna 101, a wireless reception unit 102, a CP removal unit 103, an FFT unit 104, a reference signal demultiplexing unit 105, a data processing unit 106, a channel estimation unit 107, a scheduling unit 108, a control signal generation unit 109, a wireless transmission unit 110, a transmit antenna 111, a frequency interval determination unit 112, and the cyclostationarity determination unit 113.

The receive antenna 101 receives the signal transmitted by the terminal device 200. The wireless reception unit 102 performs the down-conversion to the base band, the filtering processing, the A/D conversion, and the like, on the signal that is received by the receive antenna 101, and then inputs the result to the CP removal unit 103. The CP removal unit 103 performs removal of the CP added at the transmitting side (terminal device 200) from the signal that is input from the wireless reception unit 102, and inputs the resulting signal to the FFT unit 104.

The FFT unit 104 performs the conversion of the signal in the time domain to the signal in the frequency domain by applying the FFT at the N_{FFT} point to the signal from which the CP is removed by the CP removal unit 103. The reference signal demultiplexing unit 105 extracts a received reference signal from the signal in the frequency domain, which is obtained by the conversion by the FFT unit 104, and outputs the extracted received reference signal into the channel estimation unit 107. On the other hand, the reference signal demultiplexing unit 105 inputs a received data signal Rs, a remainder that results from extracting the received reference signal from the signal in the frequency domain, into the data processing unit 106.

The channel estimation unit 107 calculates a channel estimation value Ec for compensating for the effect of the received signal on the channel using the received reference signal being input, and inputs the calculated channel estimation value Ec into the data processing unit 106. Furthermore, the channel estimation unit 107 generates channel state information for determining which frequency is used in the next transmission, using the received reference signal being input, and inputs the generated channel state information into the scheduling unit 108 and the cyclostationarity determination unit 113. However, the calculation of the channel estimation value Ec and the calculation of the channel state information may be performed with the reference signal that is transmitted with different frequencies at different times.

The data processing unit 106 performs equalization processing, demodulation processing, and decoding processing on the received data signal Rs being input from the reference signal demultiplexing unit 105, generates a data bit B′ that is restored to its original state, and outputs the resulting data bit B′ to the outside. Moreover, when performing the equalization processing, the data processing unit 106 uses the channel estimation value Ec that is input from the channel estimation unit 107.

The scheduling unit 108 determines a subcarrier that is used for transmission by each terminal device 200, using the channel state information being input from the channel estimation unit 107, and generates the scheduling information Sc that notifies the determined subcarrier of each terminal device 200. The frequency interval determination unit 112 stores in advance information correspondence between an ID of each terminal device 200 and the frequency interval αₘ for assigning the cyclostationarity. The frequency interval determination unit 112 acquires the frequency interval αₘ that is stored in a state of being associated with the ID of terminal device 200 that is set to be a target. The cyclostationarity determination unit 113 determines the first subcarrier and the second subcarrier for assigning the cyclostationarity to the terminal device 200, using the frequency interval αₘ for the terminal device 200 that is set to be a target, which is acquired by the frequency interval determination unit 112, the scheduling information Sc on the terminal device 200, and the channel state information on the terminal device 200. The cyclostationarity determination unit 113 generates the cyclostationarity information indicating the determined first subcarrier and second subcarrier, for each terminal device 200. Moreover, the cyclostationarity determination unit 113 will be described in detail below.

The control signal generation unit 109 generates a control signal for transmitting control information, such as a modulation scheme and the coding rate, which is used by the terminal device 200, in addition to control signal for transmitting the scheduling information Sc and the cyclostationarity information. The wireless transmission unit 110 applies the D/A conversion, the filtering processing, and the up-conversion to a carrier frequency to the control signal generated by the control signal generation unit 109, and transmits the result from the transmit antenna 111. Moreover, the wireless transmission unit 110 may process a data signal destined for each terminal device 200 as well in the same manner as it processes the control signal, and may transmit the processed data signal.

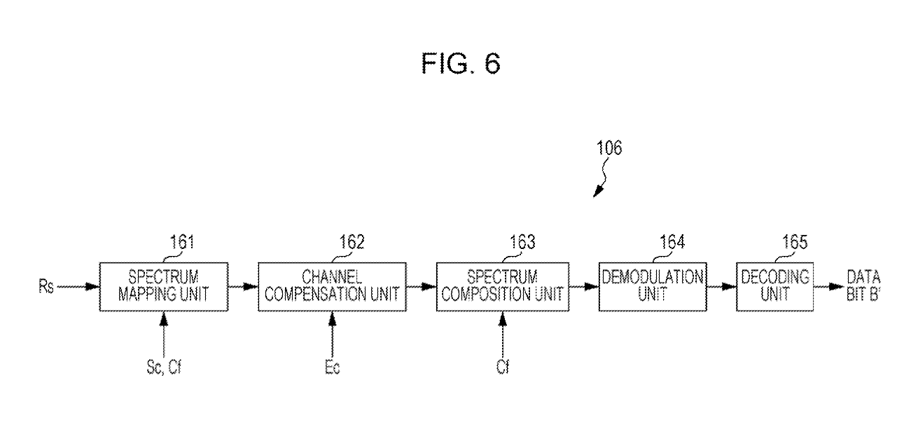

FIG. 6 is a schematic block diagram illustrating a configuration example of the data processing unit 106. The data processing unit 106 is configured to include a spectrum demapping unit 161, a channel compensation unit 162, a spectrum combination unit 163, a demodulation unit 164, and a decoding unit 165. Input into the spectrum demapping unit 161 is the received data signal Rs demultiplexed by the reference signal demultiplexing unit 105, the scheduling information Sc generated by the scheduling unit 108, and cyclostationarity information Cf generated by the cyclostationarity determination unit 113. In a case where Nₛ data subcarriers used by the terminal device 200 and a cyclostationarity assignment subcarrier are separately transmitted, the spectrum demapping unit 161 extracts such subcarriers as well from the subcarriers at the N_{FFT} point, on which the received data signal Rs is, and inputs the resulting subcarrier as a received spectrum into the channel compensation unit 162. The spectrum demapping unit 161 determines a data subcarrier referring to the scheduling information Sc, and determines the cyclostationarity assignment subcarrier (second subcarrier) referring to the cyclostationarity information Cf.

The channel compensation unit 162 calculates weight for compensating for the effect on the channel, from the channel estimation value Ec being input from the channel estimation unit 107. The channel compensation unit 162 multiplies the received spectrum being input from the spectrum demapping unit 161 by the calculated weight. Accordingly, the effect on the channel is compensated for. The channel compensation unit 162 inputs a result of the multiplication, that is, a post-compensation spectrum into the spectrum combination unit 163. In the post-compensation spectrum, the spectrum combination unit 163 combines (adds) the first subcarrier that is indicated by the cyclostationarity information Cf and a second subcarrier (cyclostationarity assignment subcarrier). The spectrum combination unit 163 adds a signal that results from the combination to the post-compensation spectrum from which the first subcarrier and the second subcarrier are removed, and inputs a result of the addition into the demodulation unit 164. Moreover, the spectrum combination unit 163 adds the signal resulting from the combination to the post-compensation spectrum from which the first subcarrier and the second subcarrier are removed by arranging the signal resulting from the combination in a position of the first subcarrier.

In a case where the second subcarrier is transmitted, because the same spectrums are transmitted with different frequencies, the spectrum combination unit 163 generates Nₛ data subcarriers by combining (adding) these, and inputs the generated Nₛ data subcarriers into the demodulation unit 164. The demodulation unit 164 performs conversion from a symbol to a bit log likelihood ratio (LLR) on each data subcarrier based on the modulation scheme applied in the demodulation unit 202 of the terminal device 200. The bit LLR resulting from the conversion is input into the decoding unit 165. The decoding unit 165 performs error correction decoding on the bit LLT being input, based on error correction coding applied in the coding unit 201 of the terminal device 200. The decoding unit 165 outputs a hard decision value of an information bit that is obtained by the error correction decoding, as the data bit B′.

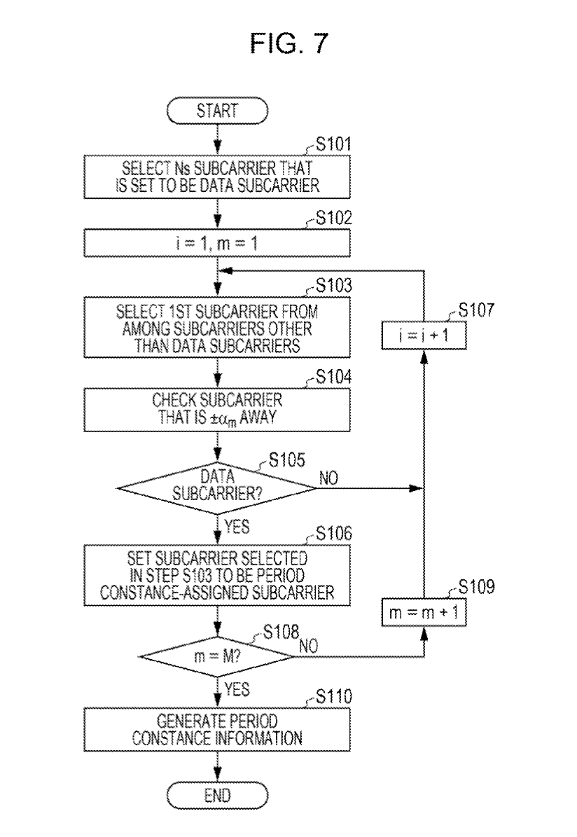

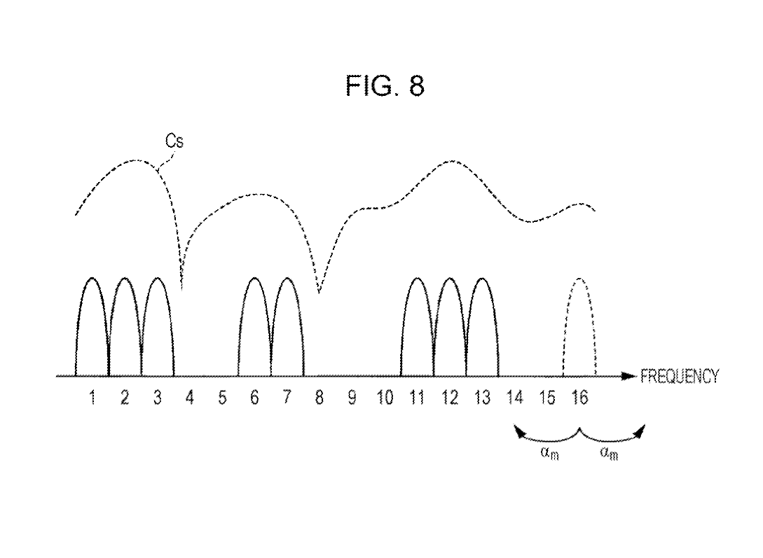

FIG. 7 is a flowchart for describing operation of the scheduling unit 108 and operation of the cyclostationarity determination unit 113. However, FIG. 7 is a flowchart in a case where the number of the data subcarrier numbers is Nₛ, and the number of the cyclostationarity assignment subcarriers is M, and a total of the (Nₛ+M) subcarriers is transmitted. In Step S101, the scheduling unit 108 determines the Nₛ subcarriers that are used as the data subcarriers, referring to the channel state information on every subcarrier. As one example of a method of the determination by the scheduling unit 108, there is a method of selecting the Nₛ subcarriers in decreasing order of a channel gain and setting these to be the Nₛ subcarriers that are used as the data subcarriers. For example, as illustrated in FIG. 8, among the (N_{FFT}=16) subcarriers, the (Nₛ=8) subcarriers (the subcarriers of which the subcarrier numbers are 1, 2, 3, 6, 7, 11, 12, and 13) are selected in decreasing order of the channel gain, and sets the selected subcarriers to be the subcarriers (data subcarrier) for data transmission.

Next, in Step S102, the cyclostationarity determination unit 113 initializes counters i, and m, in such a manner that a relationship between i and m is i=m=1. Thereafter, in Step S103, in other than the data subcarriers, the cyclostationarity determination unit 113 selects the subcarrier that has the i-th highest channel gain. Moreover, in a case where, in Step S101, the Nₛ subcarriers are selected in decreasing order of the channel gain, the cyclostationarity determination unit 113 may select the subcarrier that has the (Nₛ+i)-th highest gain, from among the N_{FFT} subcarriers. In an example in FIG. 8, the subcarrier of which the subcarrier number is 16 is selected as the subcarrier that has the (Nₛ+1)-th highest gain. Moreover, in FIG. 8, a dashed line CS indicates a channel state. Furthermore, FIG. 8 illustrates a case where the carriers of which the subcarrier numbers are 1, 2, 3, 6, 7, 11, 12, and 13 are the data subcarriers on which the data spectrums are arranged, and the frequency interval αₘ is “2”.

In Step S104, the cyclostationarity determination unit 113 checks whether or not the subcarrier that is ±αₘ away from the subcarrier selected in Step S103 is the data subcarrier or the cyclostationarity assignment subcarrier. Next, in Step S105, when the subcarrier that goes through the checking is the data subcarrier or the cyclostationarity assignment subcarrier (Yes in S105), the cyclostationarity determination unit 113 proceeds to Step S106, and, when the subcarrier is neither the data subcarrier nor the cyclostationarity assignment subcarrier (No in S105), proceeds to Step S107. Because the data spectrum is not present in the example in FIG. 8, proceeding to Step S107 takes place.

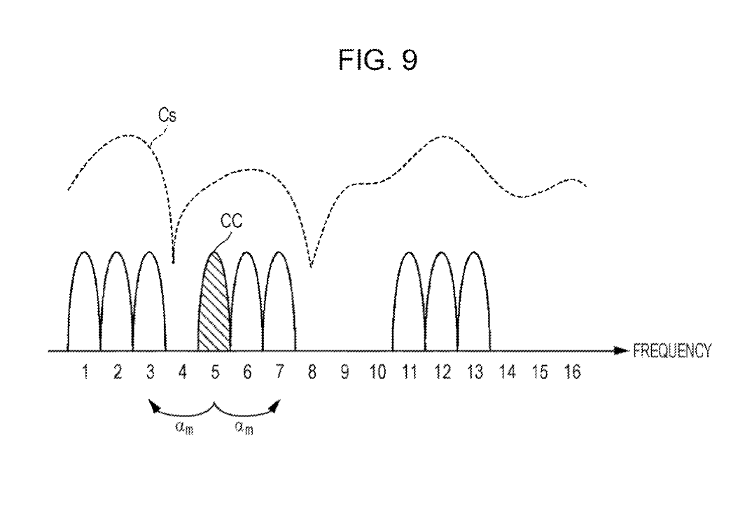

In Step S107, the cyclostationarity determination unit 113 adds 1 to a value of the counter i. With the updated value of i, Step S103 and Step S104 are again performed. For example, as a processing example in Step S103 in which i=2, in FIG. 9, a subcarrier CC of which the carrier number is 5 is selected as the (Nₛ+2)-th highest gain. In Step S106, the cyclostationarity determination unit 113 sets the subcarrier selected in Step S103 to be the cyclostationarity assignment subcarrier. Furthermore, among the subcarriers that are ±αₘ away from the subcarrier that is set to be the cyclostationarity assignment subcarrier, the cyclostationarity determination unit 113 sets the subcarrier, which is the data subcarrier or the cyclostationarity assignment subcarrier, to be the subcarrier (first subcarrier) that is the copy source when the data spectrum is copied to the cyclostationarity assignment subcarrier.

In an example in FIG. 9, the subcarrier that is ±αₘ away from the subcarrier CC of which the subcarrier number is 5 is the data subcarrier. For this reason, when the subcarrier of which the subcarrier number is 5 is selected in Step S103, in Step S106, the subcarrier of which the subcarrier number is 5 is set to be the cyclostationarity assignment subcarrier, and the subcarrier of which the subcarrier number is 3 or 7 is set to be the subcarrier that is the copy source. At this time, as illustrated in FIG. 9, when there are multiple candidates for the subcarrier that is set to be the copy source, any candidate may be the copy source. For example, a rule stipulating which candidate is set to be the copy source may be set up in advance in a communication system, and the copy source may be randomly determined.

In Step S108, the cyclostationarity determination unit 113 checks whether or not values of m and M agree with each other. In a case where the values of m and M do not do so, the cyclostationarity determination unit 113 proceeds to Steps S109, adds 1 to a value of a counter M, and again performs Steps S103 to S106. To be more precise, Steps S103 and S106 are repeated until the number of the cyclostationarity assignment subcarriers within one OFDM symbol reaches the number M of the subcarriers.

In Step S108, when m=M, to be more precise, when as many cyclostationarity assignment subcarriers as is determined in advance are selected, the cyclostationarity determination unit 113 proceeds to Step S110, and generates the cyclostationarity information indicating the selected cyclostationrity assignment subcarrier (second subcarrier) and the subcarrier (first subcarrier) that is the copy source.

Moreover, the cyclostationarity information may include the subcarrier numbers of these subcarriers as information indicating the first subcarrier and the second subcarrier. Furthermore, a frequency interval from the subcarrier number of any one of the subcarriers to another subcarrier may be included. Furthermore, because a value of the frequency interval αₘ is known in the terminal device 200, information indicating whether the frequency interval from the subcarrier number of one subcarrier to another subcarrier is positive or negative may be included. Additionally, when the positivity and negativity of the frequency interval are determined in advance, only the subcarrier number of one subcarrier may be included.

Generally, because the subcarrier that is added for the cyclostationarity assignment is a redundant subcarrier, when the number of the subcarriers for the cyclostationarity assignment is increased in order to improve the detection accuracy of the cyclostationarity, a problem of causing a decrease in a frame efficiency due to an increase in redundancy occurs. However, the scheduling unit 108 according to the present embodiment can greatly improve reception quality of the copy of the data spectrum because a subcarrier that has the highest gain is set to be the cyclostationarity assignment subcarrier, among the subcarriers, which is a subcarrier that is only the frequency interval αₘ away from the subcarriers being the data subcarrier. For this reason, because the modulation scheme or the coding rate that has the greater number of values is selected, throughput performance between terminal device 200 and the base station device 100 can be improved compared to a case where the cyclostationarity is assigned without considering the channel gain as is the case in the related art.

By assigning the cyclostationarity to the transmission signal in this manner, the terminal device 200 can notify a different terminal device 200 that the terminal device 200 itself performs the communication. Furthermore, because each of the two subcarriers for assigning the cyclostationarity is configured from data, a decrease in the frame efficiency due to the assigning of the cyclostationarity can be suppressed.

Additionally, because the cyclostationrity assignment subcarrier is received with the high channel gain in a receive antenna of the base station device 100, this can contribute to improving transmission performance without the cyclostationarity assignment subcarrier being simply redundant as is the case in the related art.

Moreover, according to the present embodiment, an example of multicarrier transmission with the OFDM being set to be a typical scheme is described but application to a broadband single carrier may be possible. In a case of the OFDM, the same data spectrums are arranged at a given frequency interval, but in the same manner in a case of the broadband single carrier, one portion (for example, one portion of a result of performing DFT) of the spectrum may be copied and a copy of the spectrum may be arranged on the subcarrier that is a given frequency interval away. At this time, because instantaneous power spectral density in the single carrier transmission is not given in frequency, in a case where a portion of the spectrum, which has small power spectral density, the detection rate is decreased. However, by setting multiple pairs within one symbol or within one frame, the probability of copying only the portion that has small power spectral density can be suppressed, and the detection rate of the cyclostationarity can be improved in a different terminal device 200.

Additionally, in the OFDM, for example, in a case where the QPAK is used as a modulation scheme, the same signal point arrangement as in a subcarrier A is transmitted with the 25% probability to a subcarrier B that is only the frequency interval αₘ away from a certain carrier A. However, because a phase or amplitude of a spectrum follows Gaussian distribution, the probability that signals on the subcarriers that are only the frequency interval αₘ away from each other will have the same phase and the same amplitude is less than ¼, and erroneous detection of the cyclostationarity can be suppressed.

### Modification Example of First Embodiment

The example is described above in which, in the cyclostationarity determination unit 113 according to the first embodiment, the subcarrier that has a high gain is preferentially set to be the cyclostationarity assignment subcarrier, but in a case where the copy of the data spectrum has a sufficiently high channel gain, there is a small need to obtain a frequency diversity effect by copying. So, according to the present modification example, the data spectrum that has a low channel gain is preferentially copied, and thus the frequency diversity effect is obtained.

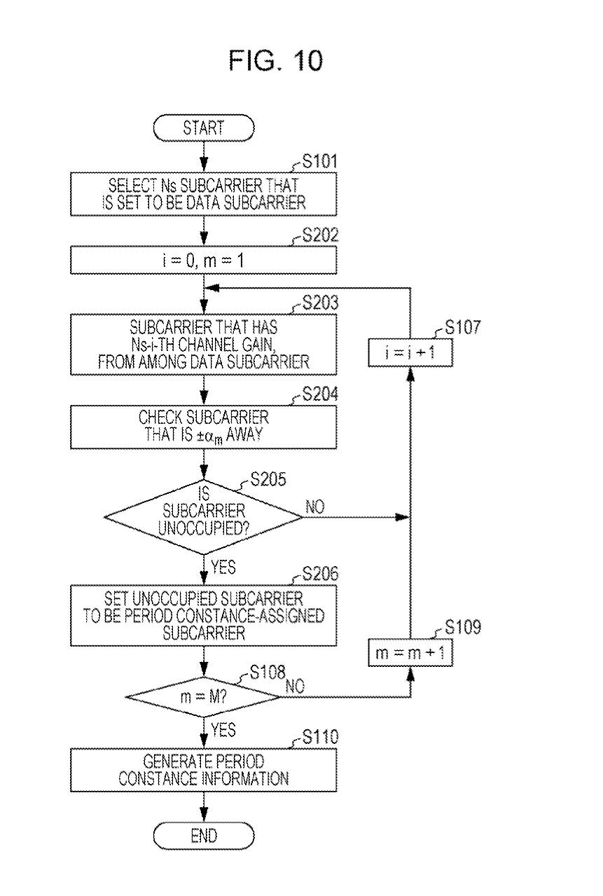

FIG. 10 is a flowchart for describing operation of the scheduling unit 108 and operation of the cyclostationarity determination unit 113. The flow chart in FIG. 10 is different from the flow chart in FIG. 7 in that the flow chart in FIG. 10 has Steps S203 to 206, instead of Steps S103 to S106. Because the other Steps S101, S102, and S107 to S110 are the same as those in FIG. 7, descriptions of them are omitted.

In Step S203, the cyclostationarity determination unit 113 selects a subcarrier that has the (Nₛ−i)-th highest gain, from among the N, subcarriers selected in Step S101, that is, among the data subcarriers. To be more precise, for the first time (i=0), a data spectrum that has the lowest gain is selected from among the data subcarriers. Next, in Step S204, the cyclostationarity determination unit 113 checks a subcarrier that is ±αₘ away from the data subcarrier that has the (Nₛ−i)-th highest data subcarrier.

Next, in Step S205, in a case where the checked subcarrier is an unoccupied subcarrier, proceeding to Step S206 takes place, and in a case where the data spectrum or the cyclostationarity assignment subcarrier is already present, proceeding to Step S107 takes place.

In Step S206, the cyclostationarity determination unit 113 sets the checked unoccupied subcarrier to be the cyclostationarity assignment subcarrier. Moreover, in a case where both subcarriers that are ±αₘ away are unoccupied subcarriers, both of the subcarriers may be set to be the cyclostationarity assignment subcarriers. Otherwise, according to a rule (for example, stipulating that a subcarrier that has a high gain is selected) that is set up in the system, any one of the subcarriers may be set to be the cyclostationarity assignment subcarrier and the subcarrier may be randomly selected.

Also in the present modification example, in the same manner as in the first embodiment, because each of the two subcarriers for assigning the cyclostationarity is configured from data, a decrease in the frame efficiency due to the assigning of the cyclostationarity can be suppressed.

Furthermore, the cyclostationarity determination unit 113 transmits the cyclostationrity assignment subcarrier by the processing described above, and thus the frequency diversity effect on the data spectrum that has the low gain is obtained.

### Second Embodiment

The method according to the first embodiment is described in which, by copying a certain data subcarrier to a subcarrier that is αₘ away, depending on the channel state, the transmission performance is improved to the maximum extent while assigning the cyclostationarity. According to the second embodiment, a method is described in which, in a case where repeating processing at the receiving side is assumed, performance improvement is maximized by the cyclostationarity assignment.

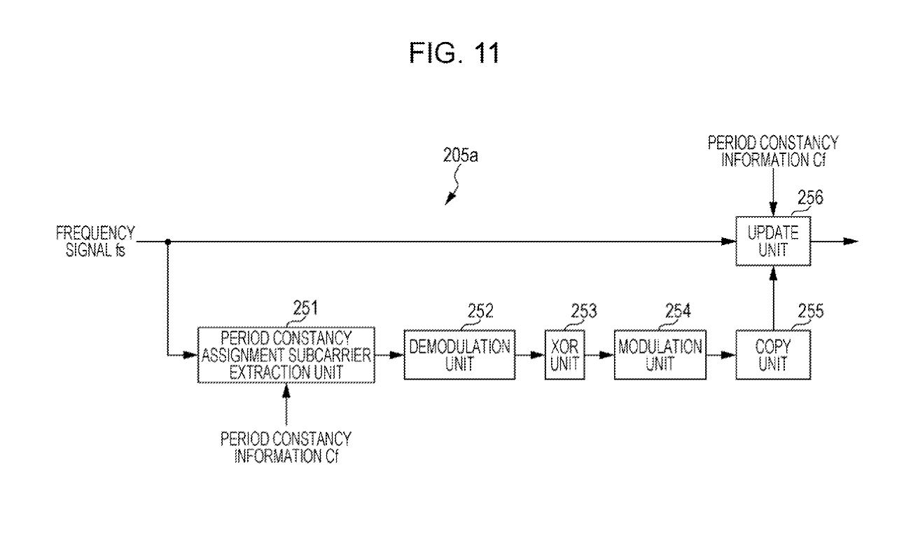

A configuration of a terminal device 200a according to the present embodiment is almost the same as that in FIG. 2, but is different from that in FIG. 2 in that the terminal device 200a has a cyclostationarity assignment unit 205a that is illustrated in FIG. 11, instead of the cyclostationarity assignment unit 205. The cyclostationarity assignment unit 205a arranges a signal that is based on an exclusive-OR between bits that are indicated by each signal on two subcarriers on each of which the data signal is arranged, on the two subcarriers, and thus establishes the correlation between the signals on the two subcarriers.

FIG. 11 is a schematic block diagram illustrating a configuration of the cyclostationarity assignment unit 205a. As illustrated in FIG. 11, the cyclostationarity assignment unit 205a is configured to include a cyclostationrity assignment subcarrier extraction unit 251, a demodulation unit 252, an XOR unit 253, a modulation unit 254, a copying unit 255, and an update unit 256.

A frequency signal fs that is input from the spectrum mapping unit 204 is input into the update unit 256 and the cyclostationarity assignment subcarrier extraction unit 251. The cyclostationarity assignment subcarrier extraction unit 251 extracts from the frequency signal fs a pair of spectrums to which the cyclostationarity designated by the cyclostationarity information Cf being input from the cyclostationarity information acquirement unit 216 is assigned. At this point, the pair of spectrums indicates a set of spectrums that are arranged on the subcarrier to which the cyclostationarity is assigned, and is equivalent to a set of the first subcarrier and the second subcarrier according to the first embodiment. According to the present embodiment, these subcarriers are data subcarriers, and subcarriers (spectrums or symbols) that are paired are different spectrums. When the multiple pairs, to each of which the cyclostationarity is assigned, are designated, spectrum extraction is performed on each of the pairs. The pair of spectrums that are extracted by the cyclostationarity assignment subcarrier extraction unit 251 is input into the demodulation unit 252.

The demodulation unit 252 performs processing for demodulation from a symbol to a bit sequence on each of the spectrums (symbols) being input. The demodulation unit 252 inputs the bit sequence that results from the demodulation processing, into the XOR unit 253. The XOR unit 253 applies an exclusive-OR (XOR) operation for every pair to the bit sequence being input from the demodulation unit 252. For example, in a case where the modulation scheme is 16 QAM, and the bit sequences in the pair of spectrums to which the cyclostationarity is assigned are ‘0010’ and ‘1011,’ ‘1001’ is output by performing XOR operation processing for every bit. In a case where the bit sequence are ‘1111’ and ‘0010’, ‘1101’ is output.

The modulation unit 254 performs conversion from the bit sequence to the symbol on the result of the operation by the XOR unit 253 in the same manner as does the demodulation unit 202. The symbol generated in the modulation unit 254 is input into the copying unit 255. The copying unit 255 copies the symbol being input, and thus generates two symbols. The copying unit 255 inputs the two symbols into the update unit 256. The update unit 256 overwrites the pair of spectrums to which the cyclostationarity designated with the cyclostationarity information Cf is assigned, with the two symbols being input from the copying unit 255, in the frequency signal fs, and inputs a result of the overwriting into the reference signal multiplexing unit 207.

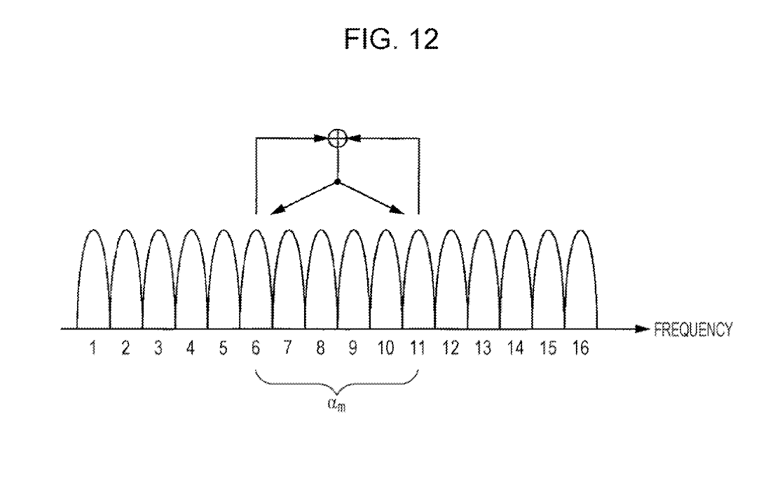

FIG. 12 is a conceptional diagram for describing processing by the cyclostationarity assignment unit 205a according to the present embodiment. FIG. 12 illustrates an example of a case where the subcarriers to which the cyclostationarity is assigned are a subcarrier of which the subcarrier number is 6 and a subcarrier of which the subcarrier number is 11. The cyclostationarity assignment unit 205a demodulates the subcarriers of which the subcarrier numbers are 6 and 11, thus converting each of the subcarriers into the bit sequence, and performs the XOR processing for every bit. Modulation processing is performed on the bit sequence obtained after the XOR processing, the resulting bit sequence is copied, and a copy of the resulting bit sequence is arranged on sixth and eleventh subcarriers. The cyclostationarity can be assigned in a transmission signal by applying the XOR or the copy. Additionally, if, although the XOR is applied, the bit sequence before applying the XOR can be restored, by the processing being performed at the receiving side, an amount of data to be transmitted is not decreased compared to that before the XOR is applied.

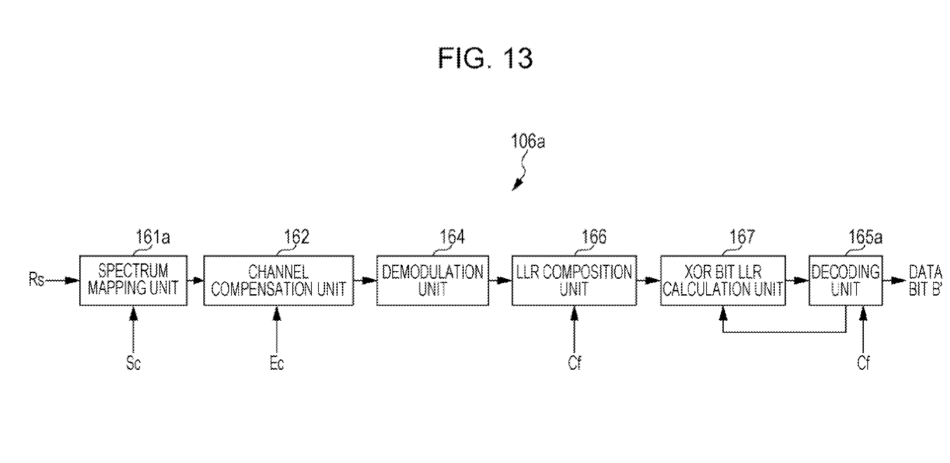

Next, a configuration of a base station device 100a according to the present embodiment is described. The configuration of the base station device 100a according to the present embodiment is almost the same as that in FIG. 5, but is different from that in FIG. 5, in that the base station device 100a has the data processing unit 106a that is illustrated in FIG. 13 instead of the data processing unit 106 and has the cyclostationarity determination unit 113a instead of the cyclostationarity determination unit 113.

The cyclostationarity determination unit 113a is different from the cyclostationarity determination unit 113, selects two subcarriers that are the frequency interval αₘ away from each other, from among the subcarriers on which the data signal is arranged, which are indicated with the scheduling information Sc, and sets these to be a set of subcarriers for assigning the cyclostationarity. The cyclostationarity determination unit 113a generates the cyclostationarity information Cf that indicates the set of subcarriers. Moreover, when selecting the set of subcarriers, for example, the cyclostationarity determination unit 113a selects a subcarrier that has the lowest gain and a subcarrier that is the frequency interval αₘ away from the subcarrier, from among the subcarriers to which the data signal is arranged. Moreover, a determination may be made using other methods. Furthermore, multiple sets of subcarriers for assigning the cyclostationarity may be selected.

FIG. 13 is a schematic block diagram illustrating a configuration of the data processing unit 106a according to the present embodiment. In FIG. 13, components corresponding to the units in FIG. 6 are given the same reference numerals 162 and 164, and detailed descriptions of them are omitted. The data processing unit 106a is configured to include a spectrum demapping unit 161a, the channel compensation unit 162, the demodulation unit 164, an LLR combination unit 166, an XOR bit LLR calculation unit 167, and a decoding unit 165a.

Input into the spectrum demapping unit 161a is the received data signal Rs being input from the reference signal demultiplexing unit 105. The spectrum demapping unit 161a extracts Nₛ data subcarriers that are used for the communication by the terminal device 200, from the subcarriers at the N_{FFT} point, which make up the received data signal Rs. The spectrum demapping unit 161a inputs the extracted data subcarriers, as the received spectrum, into the channel compensation unit 162. Moreover, referring to the scheduling information Sc, the spectrum demapping unit 161a determines which subcarrier is the data subcarrier.

The channel compensation unit 162 compensates for the effect on the channel, from the channel estimation value Ecbeing input from the channel estimation unit 107, using the channel estimation value Ec being input from the channel estimation unit 107 for the received spectrum being input from the spectrum demapping unit 161a. The channel compensation unit 162 inputs a post-compensation spectrum into the demodulation unit 164. The demodulation unit 164 performs conversion from the symbol to the bit LLR, based on the modulation scheme applied in the terminal device 200a. The demodulation unit 164 inputs the bit LLR obtained by the conversion into the LLR combination unit 166.

The LLR combination unit 166 combines (adds) the bit LLR's that correspond to bits that are XOR-processed by the XOR unit 253 in FIG. 11. The LLR combination unit 166 overwrites each pre-composition bit LLR with the bit LLR that results from the combination, and inputs the result to the XOR bit LLR calculation unit 167. To be more precise, the post-combination LLR is shared among the multiple bits to which an XOR operation is applied. At this time, referring to the cyclostationarity information Cf, the LLR combination unit 166 determines which bit LLR corresponds to the bit that is XOR-processed. Moreover, the example in which, according to the present embodiment, the post-demodulation LLR's are combined is described, but in the same manner as in the first embodiment, a configuration may be possible in which a spectrum combination unit is provided between the channel compensation unit 162 and the demodulation unit 164 in order to combine the spectrums after the channel compensation.

The XOR bit LLR calculation unit 167 separates the bit LLR that results from the combination by the LLR combination unit 166, among the bit LLR's that are input from the LLR combination unit 166, into the two bit LLR's that correspond to the two bits that are present before the XOR operation (XOR processing) is performed by the XOR unit 253 in FIG. 11, and inputs the resulting two bit LLR's into the decoding unit 165a, along with the other bit LLR's. As an example, a case where, for example, the XOR unit 253 XOR-processes a bit A and a bit B, and a bit C that results from the XOR processing is transmitted is described. When an LLR of the bit C that results from the combination by the LLR combination unit 166 is set to be L(C), the XOR bit LLR calculation unit 167 calculates L(A), which is an LLR of the bit A, by Equation (1) that follows.

$$L ( A ) = log \frac{exp ( {L}^{′} ( B ) ) + exp ( L ( C ) )}{1 + exp ( {L}^{′} ( B ) + L ( C ) )} \qquad Equation ( 1 )$$

In Equation (1), L′(B) is an LLR of the bit B that is input from the decoding unit 165a. On the other hand, in the same manner, the XOR bit LLR calculation unit 167 calculates L(B) that is an LLR of the bit B, by Equation (2).

$$L ( B ) = log \frac{exp ( {L}^{′} ( A ) ) + exp ( L ( C ) )}{1 + exp ( {L}^{′} ( A ) + L ( C ) )} \qquad Equation ( 2 )$$

In Equation (2), L′(A) is an LLR of the bit A that is input from the decoding unit 165a. Moreover, the XOR bit LLR calculation unit 167 and the decoding unit 165 perform the repeating processing that alternately repeats processing, but the first time that the repeating processing is performed, the L′(A) and the L′(B) that are the bit LLR's that are input into the XOR bit LLR calculation unit 167 from the decoding unit 165 are set to zero. At this time, Equation (1) becomes like Equation that follows.

$$\begin{matrix}L ( A ) = log \frac{exp ( 0 ) + exp ( L ( C ) )}{1 + exp ( L ( C ) )} \\ = 0\end{matrix} \qquad Equation ( 3 )$$

To be more precise, the first time that the repeating processing is performed, a value of the L(A) is zero regardless of a value of the L(C). In the same manner, the L(B) is zero. On the other hand, the second time that the repeating processing is performed and later, because the L′(A) and the L′(B) are feedback from the decoding unit 165, the XOR bit LLR calculation unit 167 inputs the L(A) and the L(B) that are updated by performing operations using Equations (1) and (2), into the decoding unit 165a.

The decoding unit 165a performs the error correction decoding on the bit LLR being input from the XOR bit LLR calculation unit 167 based on the error correction coding applied in the terminal device 200a. Among the results of the decoding by the error correction decoding, the decoding unit 165a inputs a result of the decoding associated with the bit on which the XOR operation is performed at the transmitting side, as an external LLR, into the XOR bit LLR calculation unit 167. That is, the decoding unit 165a inputs the L′(A) and the L′(B) described above into the XOR bit LLR calculation unit 167. In the XOR bit LLR calculation unit 167, the external LLR is used like the L′(A) and the L′(B) of information bits in Equation (1) and Equation (2).

After LLR substitution is repeated an arbitrary number of times in the XOR bit LLR calculation unit 167 and the decoding unit 165a, the decoding unit 165a outputs the LLR of the information bit as the data bit B′ that results from the hard decision.

Moreover, the second time that the repeating processing is performed and later, the decoding unit 165a may perform the error correction decoding on a bit LLR sequence that results from overwriting the result of the last decoding with the L(A) and the L(B) that are calculated by the XOR bit LLR calculation unit 167, and may perform the error correction decoding on a bit LLR sequence that results from overwriting a bit LLR sequence on which the decoding processing is not performed, which is input by the XOR bit LLR calculation unit 167, with the L(A) and the L(B).

The case is described where, in this manner, the terminal device 200a compresses a transmission bit by performing the XOR operation, transmits the same spectrum on the unoccupied subcarrier that is generated by the compression, and thus the cyclostationarity is assigned. Because the data subcarrier is used as the two subcarriers for assigning the cyclostationarity, the cyclostationarity can be assigned without decreasing the frame efficiency.

Furthermore, because the data compressed by the XOR is decompressed by the repeating processing in the base station device 100a, a decrease in an amount of information due to the compression can be suppressed. Additionally, because a frequency diversity gain can also be obtained by transmitting the same spectrum on the multiple subcarrier, it is possible to improve the transmission performance as well, compared to a case where the XOR is not applied.

Moreover, according to each of the embodiments described above, the copying of the signal or the calculation of the exclusive-OR between the bits that are indicated by the signal is performed in the cyclostationarity assignment units 205 and 205a after the spectrum mapping unit 204. However, the copying of the signal may be performed before the spectrum mapping unit 204, and the calculation of the exclusive-OR between the bits may be performed before the modulation.

Furthermore, according to each of the embodiments described above, the base station devices 100 and 100a are described as including the cyclostationarity determination units 113 and 113a, respectively, but the terminal devices 200 and 200a may include the cyclostationarity determination units 113 and 113a, respectively. Moreover, in this case, the base station devices 100 and 100a notify the terminal devices 200 and 200a, respectively, of a gain of each subcarrier, and referring to the notified gain, the cyclostationarity determination units 113 and 113a determine the subcarrier for assigning the cyclostationarity. Otherwise, if the same frequency band is used in uplink and downlink, a gain in the downlink is measured in the terminal device 200 and 200a, and referring to the gain, the cyclostationarity determination units 113 and 113a may determine the subcarrier for assigning the cyclostationarity.

Furthermore, the case is described where, according to each of the embodiments described above, the information that has to be notified with the cyclostationarity is an ID of the terminal device 200 or 200a, but may be information that notifies other pieces of information. Furthermore, according to each of the embodiments described above, the terminal devices 200 and 200a notify the ID using the cyclostationarity, but the base station device may notify the ID or other information using the cyclostationarity.

Furthermore, according to each of the embodiments described above, the devices that detect the cyclostationarity are different devices 200 and 200a, but may be devices other than the devices 200 and 200a. For example, the base station devices 100 and 100a that are the other communication parties may be available and other base station devices may be available.

A program for realizing all functions or some functions of the terminal devices 200 and 200a and the base station devices 100 and 100a according to each of the embodiments may be recorded on a computer-readable recording medium, and a computer system may be caused to read and execute the program recorded on the recording medium, thereby realizing each of the devices. Moreover, the “computer system” here is defined as including an OS and hardware components such as a peripheral device.

Furthermore, the “computer-readable recording medium” refers to a portable medium such as a flexible disk, a magneto-optical disk, a ROM, and a CD-ROM, and a storage device such as a hard disk that is built into the computer system. Moreover, the “computer-readable recording medium” is defined as including whatever dynamically includes the program for a short period of time, such as a communication line that is used when transmitting the program over a network such as the Internet or over a communication circuit such as a telephone circuit and as including whatever retains the program for a given period of time, such as a volatile memory within the computer system, which functions as a server or a client in the case of including the program dynamically. Furthermore, the program may be one for realizing some of the functions described above and additionally may be one that can realize the functions described above in combination with a program that is already recorded on the computer system.

Furthermore, some of the functions or all of the functions of the terminal devices 200 and 200a and the base station devices 100 and 100a according to each of the embodiments described above may be realized as an LSI that is a typical integrated circuit. Each functional block of the terminal devices 200 and 200a and the base station devices 100 and 100a may be individually realized in a chip, and some of, or all of the functional blocks may be integrated into a chip. Furthermore, a technique of the integrated circuit is not limited to the LSI, and an integrated circuit for the functional block may be realized as a dedicated circuit or a general-purpose processor. The integrated circuit may be any one of hybrid and monolithic circuits. Furthermore, some functions that are performed by the program may be realized in software and some functions may be realized in hardware.

The embodiments of the invention are described in detail above referring to the drawings, but the specific configuration is not limited to the embodiments and includes an amendment to a design that falls within a scope not departing from the gist of the present invention.

### REFERENCE SIGNS LIST

10 WIRELESS COMMUNICATION SYSTEM
100, 100a BASE STATION DEVICE
101 RECEIVE ANTENNA
102 WIRELESS RECEPTION UNIT
103 CP REMOVAL UNIT
104 FFT UNIT
105 REFERENCE SIGNAL DEMULTIPLEXING UNIT
106, 106a DATA PROCESSING UNIT
107 CHANNEL ESTIMATION UNIT
108 SCHEDULING UNIT
109 CONTROL SIGNAL GENERATION UNIT
110 WIRELESS TRANSMISSION UNIT
111 TRANSMIT ANTENNA
112 FREQUENCY INTERVAL DETERMINATION UNIT
113 CYCLOSTATIONARITY DETERMINATION UNIT
161, 161a SPECTRUM DEMAPPING UNIT
162 CHANNEL COMPENSATION UNIT
163 SPECTRUM COMBINATION UNIT
164 DEMODULATION UNIT
165, 165a DECODING UNIT
166 LLR COMBINATION UNIT
167 XOR BIT LLR CALCULATION UNIT
200, 200a TERMINAL DEVICE
201 CODING UNIT
202 MODULATION UNIT
204 SPECTRUM MAPPING UNIT
205, 205a CYCLOSTATIONARITY ASSIGNMENT UNIT
206 REFERENCE SIGNAL GENERATION UNIT
207 REFERENCE SIGNAL MULTIPLEXING UNIT
208 IFFT UNIT
209 CP ADDITION UNIT
210 WIRELESS TRANSMISSION UNIT
211 TRANSMIT ANTENNA
212 RECEIVE ANTENNA
213 WIRELESS RECEPTION UNIT
214 CONTROL INFORMATION ACQUIREMENT UNIT
215 SCHEDULING INFORMATION ACQUIREMENT UNIT
216 CYCLOSTATIONARITY INFORMATION ACQUIREMENT UNIT
217 ID ACQUIREMENT UNIT
251 CYCLOSTATIONARITY ASSIGNMENT SUBCARRIER EXTRACTION UNIT
252 DEMODULATION UNIT
253 XOR UNIT
254 MODULATION UNIT
255 COPYING UNIT
256 UPDATE UNIT
261 CP REMOVAL UNIT
262 FFT UNIT
263-1, 263-N SIGNAL EXTRACTION UNIT
264-1, 264-N CORRELATION DETECTION UNIT
265 ID DETECTION UNIT

1. A communication system comprising:
a first communication device; and
a second communication device,
wherein the first communication device or the second communication device includes a frequency interval determination unit that determines a predetermined frequency interval according to information that has to be notified to a different device by the first communication device, and
wherein the first communication device includes a cyclostationarity assignment unit that establishes a correlation between signals on two subcarriers that are the predetermined frequency interval away from each other, the two subcarriers including at least one subcarrier on which a data signal to be transmitted to the second communication device is arranged.

2. The communication system according to claim 1,
wherein the cyclostationarity assignment unit establishes the correlation between the signals on the two subcarriers by arranging a copy of the signal on one subcarrier of the two subcarriers, on which the data signal is arranged, on the other subcarrier.

3. The communication system according to claim 2,
wherein the other carrier is a subcarrier on which the data signal is not arranged, and
wherein the first communication device or the second communication device includes a cyclostationarity determination unit that selects a subcarrier on which the data signal is not arranged and which has the highest gain, from among the subcarriers, the data signal being arranged on a subcarrier that is the predetermined frequency interval away from the subcarriers, and sets the selected subcarrier to be the other subcarrier.

4. The communication system according to claim 2,
wherein the first communication device or the second communication device include a cyclostationarity determination unit that selects a subcarrier that has the lowest gain from among subcarriers on each of which the data signal is arranged, and sets the selected subcarrier to be the one subcarrier.

5. The communication system according to claim 1,
wherein the two subcarriers are subcarriers on each of which the data signal is arranged, and
wherein the cyclostationarity assignment unit arranges a signal that is based on an exclusive-OR between bits that are indicated by each signal on the two subcarriers, and thus establishes the correlation between the signals on the two subcarriers.

6. The communication system according to claim 5,
wherein the second communication device includes
a combination unit that combines pieces of information relating to the signal that is based on the exclusive-OR, in a signal received from the first communication device,
a decoding unit that decodes the received signal, and
a XOR bit calculation unit that calculates information indicating a value of the bit that results from the exclusive-OR, from a result of the combination by the combination unit and a result of the decoding by the decoding unit.

7. A communication device that communicates with a first communication device that establishes a correlation between signals on two subcarriers that are a predetermined frequency interval away from each other, the two subcarriers including at least one subcarrier on which a data signal to be transmitted is arranged, the device comprises:
a frequency interval determination unit that determines the predetermined frequency interval according to information that has to be notified to a different device by the first communication device.

8. A communication device comprising:
a cyclostationarity assignment unit that establishes a correlation between signals on two subcarriers that are a predetermined frequency interval away from each other, the two subcarriers including at least one subcarrier on which a data signal to be transmitted to a different communication device is arranged.

9. (canceled)
